(19) United States
(12) Patent Application Publication
(10) Pub. No.: US 2009/0234464 A1
(43) Pub. Date: Sep. 17, 2009

(54) INTERFACE INFORMATION OUTPUTTING SYSTEM

(76) Inventor: Yoshiki SUZUKI, Kanagawa (JP)

Correspondence Address: TAFT, STETTINIUS & HOLLISTER LLP, SUITE 1800, 425 WALNUT STREET, CINCINNATI, OH, 45202-3957, US

(21) Appl. No.: 12/395,835

(22) Filed: Mar. 2, 2009

(30) Foreign Application Priority Data
Mar. 14, 2008 (JP) 2008-065730

(51) Int. Cl. G05B 13/02

(52) U.S. Cl. 700/11; 700/21

(57) ABSTRACT

An interface information outputting system that maintains consistency between control parameter data set in a control information terminal by an operator and control parameter data set in an interface output section. In an embodiment, a control instructing section causes a status information generating and sending section to send its own ID information signal and a status information signal indicating its own present operational conditions to the control information terminal via a communication line. In the event of an abnormal operational condition, the control information terminal resends the control parameter data to the control instructing section identified by the ID information signal.

### CROSS REFERENCE TO RELATED APPLICATION

This application claims the benefit of Japanese Patent Application No. 2008-065730, filed Mar. 14, 2008, which is incorporated by reference.

### BACKGROUND

The present disclosure relates to interface information outputting systems and, more particularly, to interface information outputting systems that control an output instrument (such as a display, a speaker, or a printer, for example) which provide an interface output (such as an image display output, a voice output, or a printed output, for example) that can be sensed by a human being, over a communication line (including a wired or wireless network, for example) by means of a communication method (such as USB communication, for example).

Japanese Patent Application Laid-Open No. 1993-189393, which is incorporated by reference, discloses an interface information outputting system. Until the control information terminal is operated, when power is disconnected and then power is reapplied to the control instructing section, when restarting the control instructing section, or when communication between the control information terminal and the control instructing section is disconnected, inconsistencies may occur between control parameter data displayed on a screen of the control information terminal and control parameter data set in the interface output section. In order to solve this inconsistency, the control information terminal may monitor communication between the control information terminal and the control instructing section or may periodically retransmit control parameter data. However, in these methods, the size of the control information terminal and the communication load between the control information terminal and the control instructing section are increased.

### SUMMARY

In an exemplary interface information outputting system, a control side and an output side cooperate so that control parameter data transmitted via a control instructing section is set in an interface output section by operation of a control information terminal by an operator. The control information terminal receives a response message from the control instructing section indicating the completion of the setting of the control parameter.

Exemplary embodiments provide an interface information outputting system that maintains consistency between control parameter data displayed on a screen of the control information terminal and control parameter data set in the interface output section, without increasing the control information terminal size and without increasing the communication load between the control information terminal and the control instructing section, even when power is reapplied to the control instructing, when the control instructing section is restarted, and when communication is disconnected, or the like, until the control information terminal is operated.

In an aspect, an interface information outputting system may include a control information terminal operative to supply control parameter data via a communication line; a control instructing section operative to receive the control parameter data via the communication line and to output a control instructing signal on the basis of the received control parameter data; and an interface output section operative to perform an interface output in accordance with the control instructing signal received from the control instructing section. The control instructing section may include a status information generating and sending section that is operative to send to the control information terminal via the communication line an ID information signal including information pertaining to an identity of the control instructing section and a status information signal including status information indicating present operational conditions; and the control information terminal may be operative to receive the status information signal via the communication line and to utilize at least a portion of information from the status information signal in control parameter data sent subsequently therefrom.

In a detailed embodiment, the status information signal may include a retransmission request for the control parameter data, the retransmission request corresponding to the present operational conditions of the control instructing section; and the control information terminal may be operative to utilize at least a portion of information from the retransmission request in control parameter data sent subsequently therefrom.

In a detailed embodiment, the communication line may include a wired connection.

In a detailed embodiment, the communication line may include a wireless connection.

In a detailed embodiment, the status information signal may include status information indicating at least one abnormal condition. In a further detailed embodiment, the at least one abnormal condition may include at least one of power OFF-ON, communication disconnection, and restarting.

In a detailed embodiment, the status information signal may include status information indicating normal termination.

In an aspect, a method of providing a control instructing signal may include supplying a control parameter from a control information terminal via a communication line; receiving the control parameter by a control instructing section via the communication line; outputting, by the control instructing section, a control instructing signal based on the received control parameter data; receiving, by an interface output section, receiving the control instructing signal from the control instructing section; and performing, by the interface output section, an interface output in accordance with the control instructing signal. The control instructing section may include a status information generating and sending section that is operative to send to the control information terminal via the communication line (a) an ID information signal including information pertaining to an identity of the control instructing section and (b) a status information signal including status information indicating present operational conditions; and the control information terminal may be operative to receive the status information signal via the communication line and to utilize at least a portion of information from the status information signal in control parameter data sent subsequently therefrom.

In a detailed embodiment, the status information signal may include a retransmission request for the control parameter data, the retransmission request corresponding to the present operational conditions of the control instructing section; and the control information terminal may be operative to utilize at least a portion of information from the retransmission request in control parameter data sent subsequently therefrom.

### BRIEF DESCRIPTION OF THE DRAWINGS

The detailed description refers to the Figures in which:

FIG. 1 is a functional block diagram illustrating a schematic configuration of an exemplary interface information outputting system;

FIG. 2 is a sequence diagram illustrating exemplary processing procedures of the control information terminal, the status information generating and sending section, the device driver, and the interface in the exemplary interface information outputting system illustrated in FIG. 1;

FIG. 3 is a sequence diagram illustrating exemplary processing procedures of the control information terminal, the status information generating and sending section, the device driver, and the interface in the exemplary interface information outputting system illustrated in FIG. 1;

FIG. 4 is a sequence diagram illustrating exemplary processing procedures of the control information terminal, the status information generating and sending section, the device driver, and the interface in the exemplary interface information outputting system illustrated in FIG. 1;

FIG. 5 is a sequence diagram illustrating exemplary processing procedures of the control information terminal, the status information generating and sending section, the device driver, and the interface in the exemplary interface information outputting system illustrated in FIG. 1;

FIG. 6 is a sequence diagram illustrating exemplary processing procedures of the control information terminal, the status information generating and sending section, the device driver, and the interface in the exemplary interface information outputting system illustrated in FIG. 1;

FIG. 7 is a sequence diagram illustrating exemplary processing procedures of the control information terminal, the status information generating and sending section, the device driver, and the interface in the exemplary interface information outputting system illustrated in FIG. 1;

FIG. 8 is a flowchart illustrating processing procedures of the control information terminal 2 in the exemplary interface information outputting system illustrated in FIG. 1;

FIG. 9A is a flowchart illustrating exemplary processing procedures of the status information generating and sending section in the exemplary interface information outputting system illustrated in FIG. 1; and

FIG. 9B is a flowchart illustrating exemplary processing procedures of the status information generating and sending section in the exemplary interface information outputting system illustrated in FIG. 1.

### DETAILED DESCRIPTION

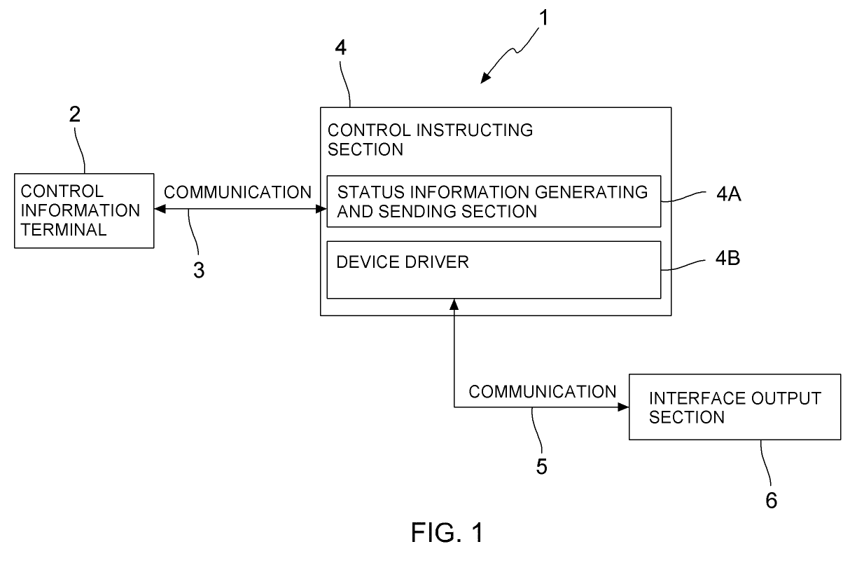

FIG. 1 illustrates an exemplary interface information outputting system 1, which includes a control information terminal 2 into which control parameter data is input by an operator using an input apparatus such as a keyboard. A control instructing section 4 and the control information terminal 2 communicate with each other via a wireless or a wired connection, and the control instructing section 4 and the control information terminal 2 send and receive control parameter data and response messages. The control instructing section 4 includes a status information generating and sending section 4A that receives the control parameter data sent from the control information terminal 2, generates response messages including a signal related to a setting processing result for the control parameter data, and sends the response message to the control information terminal 2. The control instructing section 4 includes a device driver 4B that controls an interface output section 6 on the basis of contents of the control parameter data received from the control information terminal 2 by way of the status information generating and sending section 4A.

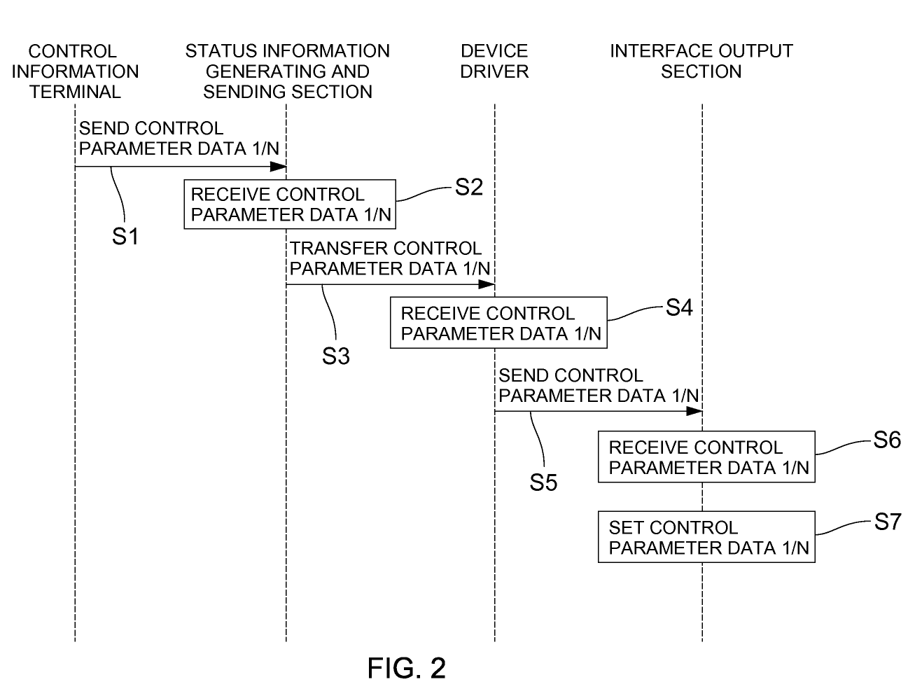

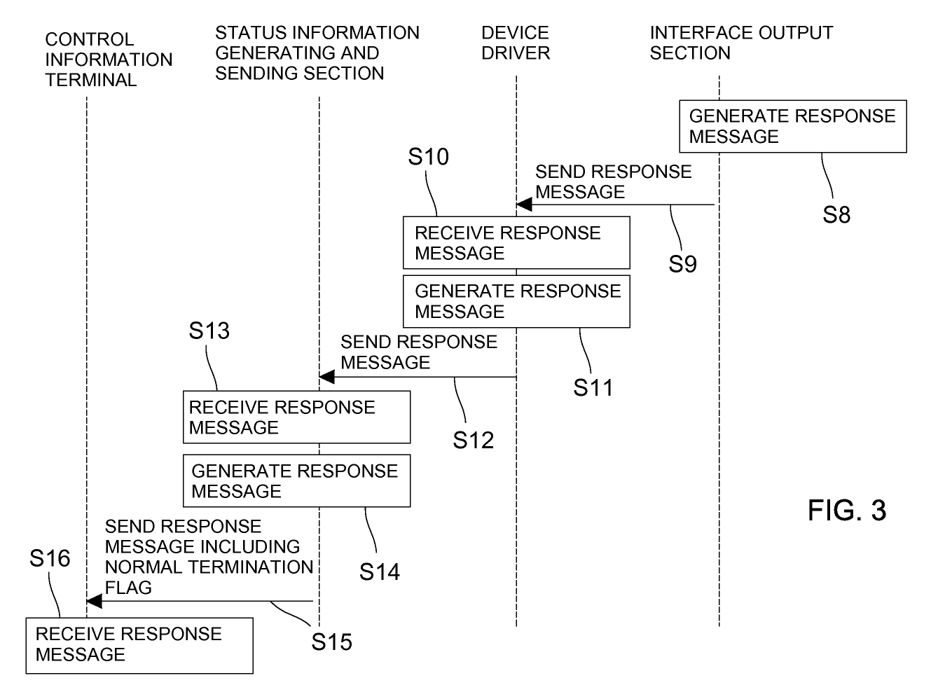

FIGS. 2 and 3 depict exemplary operations when n pieces of control parameter data (n is an integer number more than or equal to 1) set in the control information terminal 2 are set in the interface output section 6 normally.

The operator of the control information terminal 2 inputs n pieces of control parameter data (hereinafter, simply referred to as control parameter data) into the control information terminal 2 using the input apparatus to determine the operation of the interface output section 6. The control information terminal 2 acquires the input control parameter data and sends an initial one of the input control parameter data pieces (hereinafter, referred to as control parameter data 1/n) to the status information generating and sending section 4A in the control instructing section 4 (step S1). The status information generating and sending section 4A receives the control parameter data 1/n sent from the control information terminal 2 (step S2). The status information generating and sending section 4A transfers the control parameter data 1/n to the device driver 4B so that the control parameter data 1/n can be set in the interface output section 6 (step S3).

The device driver 4B receives the control parameter data 1/n transferred from the status information generating and sending section 4A (step S4). Since the transferred control parameter data 1/n is to be set in the interface output section 6, the device driver 4B sends the control parameter data 1/n to the interface output section 6 (step S5). The interface output section 6 receives the control parameter data 1/n sent in step S5 (step S6), and then sets the received control parameter data 1/n therein (step S7).

When the control parameter data 1/n is set normally, the interface output section 6 generates a response message including the result that the setting of the control parameter data 1/n in the interface output section has been terminated normally, assigns the response message to the device driver 4B (step S8), and sends the response message to the device driver 4B (step S9). After receiving the response message from the interface output section 6 (step S10), the device driver 4B generates a response message including the result that the setting of the control parameter data 1/n has been terminated normally, assigns the response message to the status information generating and sending section 4A (step S11), and sends the response message to the status information generating and sending section 4A (step S12).

When the status information generating and sending section 4A receives the response message from the device driver 4B (step S13), the status information generating and sending section 4A generates a response message having a normal termination flag included in a status information signal region, which indicates that the setting of the control parameter data 1/n has been terminated normally, assigns the response message to the control information terminal 2 (step S14), and sends the response message to the control information terminal 2 (step S15). The control information terminal 2 receives the response message sent from the status information generating and sending section 4A (step S16), and terminates the process.

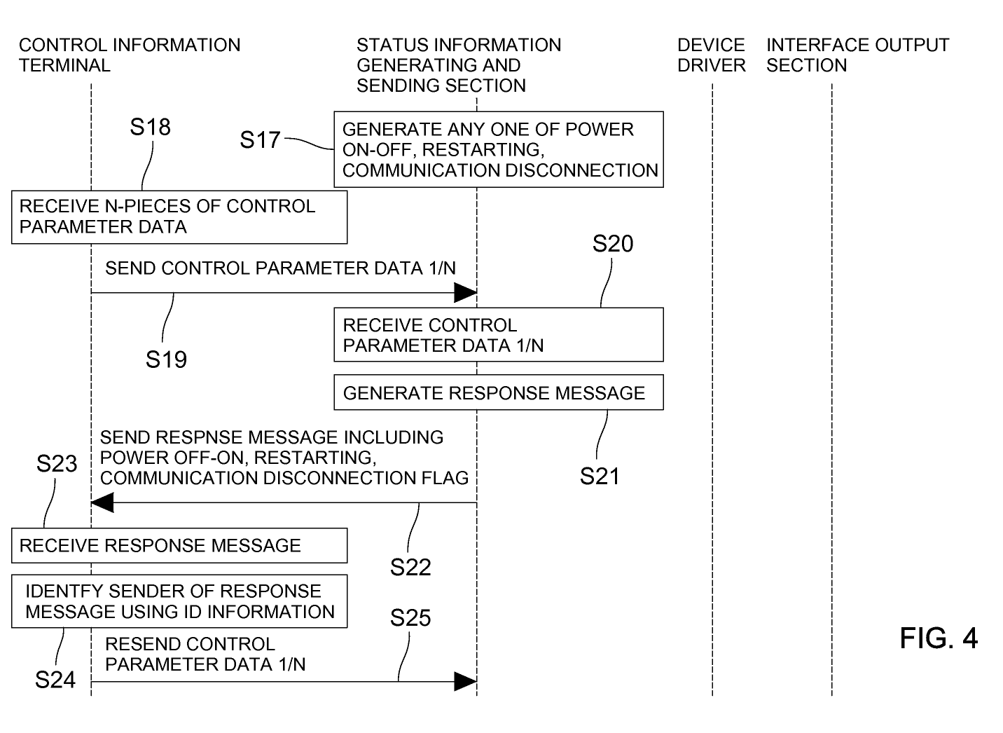

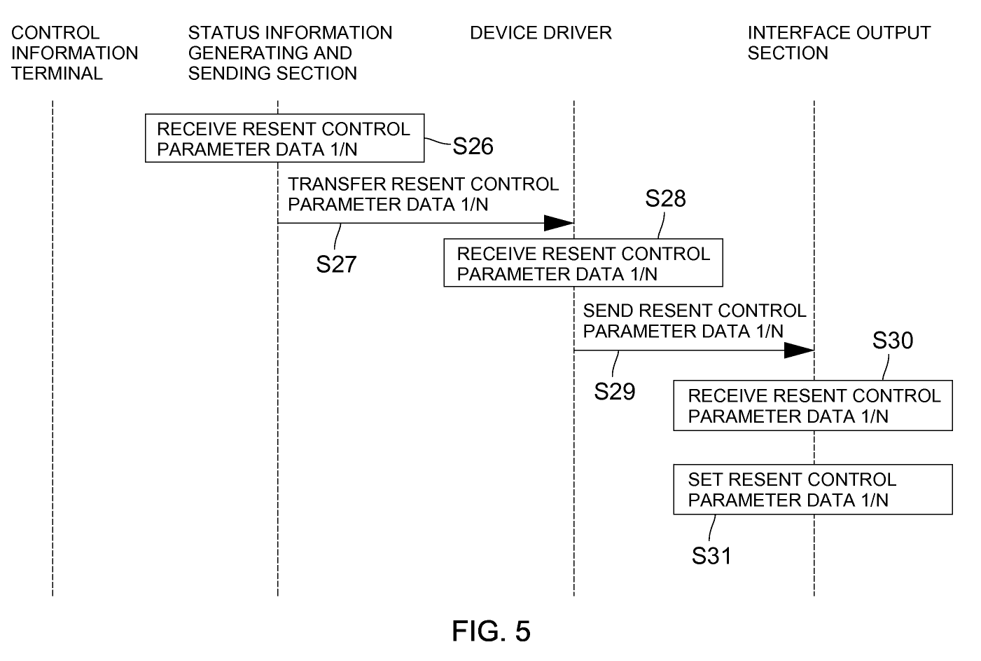

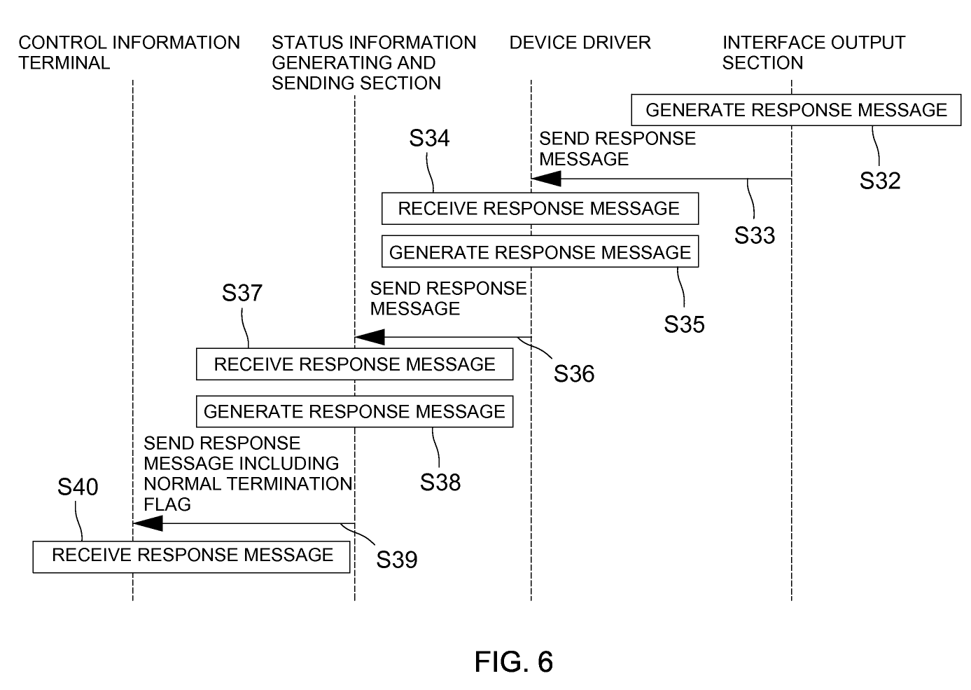

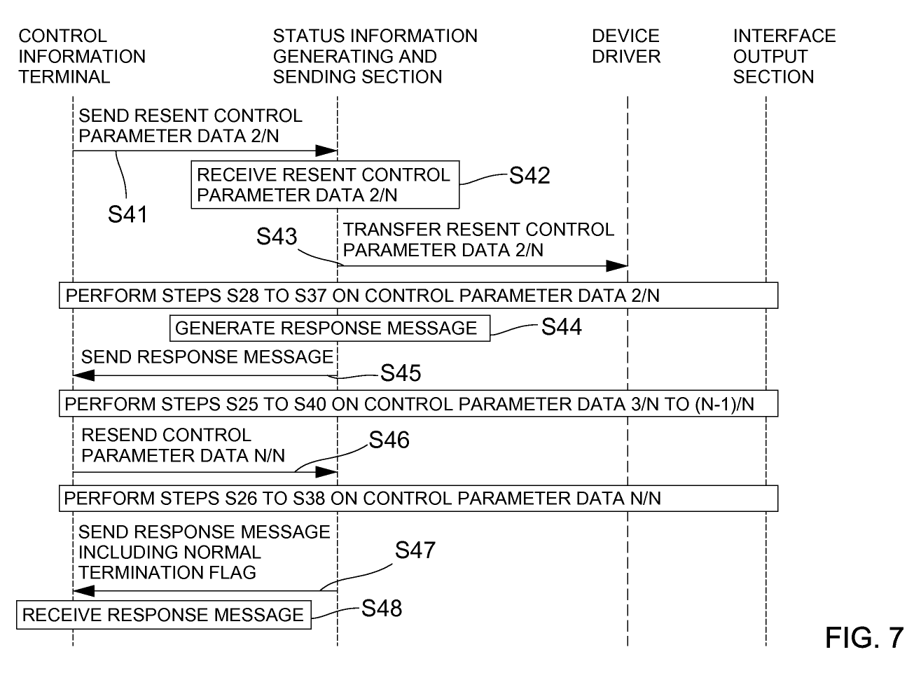

FIGS. 4 to 7 depict exemplary operations when the control parameter data 1/n set in the control information terminal 2 has not been set normally in the interface output section 6 because the power supply to the control instructing section 4 is turned OFF-ON, communication is disconnected, or restarting is performed.

If the power supply is turned OFF-ON, the communication is disconnected, or restarting has occurred in the control instructing section 4 (step S17), the operator of the control information terminal inputs n pieces of control parameter data (n is an integer number more than or equal to 1) for determining the operation of the interface output section 6 into the control instructing section 4 using the input apparatus. Here, the control information terminal 2 receives the input control parameter data (step S18) and then sends the control parameter data 1/n to the status information generating and sending section 4A (step S19), and the status information generating and sending section 4A receives the control parameter data 1/n (step S20). Here, the status information generating and sending section 4A makes a response message having any one of a power supply OFF-ON flag, a communication disconnection flag, and a restarting flag included in the status information signal region within the corresponding response message. The response message is assigned to the control information terminal 2 (step S21).

After that, the status information generating and sending section 4A sends the response message having any one of the power supply OFF-ON flag, the communication disconnection flag, and the restarting flag included in the status information signal region, which is made in step S21, to the control information terminal 2 (step S22).

After receiving the response message sent in step S22 (step S23), the control information terminal 2 identifies the sender of the response message from ID information stored in an ID information signal region within the response message (step S24), and resends the control parameter data 1/n (n is an integer number more than or equal to 1) to the sender (step S25).

The status information generating and sending section 4A receives the resent control parameter data 1/n (hereinafter, referred to as resent control parameter data 1/n) (step S26), and transfers the resent control parameter data 1/n to the device driver 4B so that the resent control parameter data 1/n can be set in the interface output section 6 (step S27).

The device driver 4B receives the resent control parameter data 1/n transferred from the status information generating and sending section 4A (step S28). The device driver 4B sends the resent control parameter data 1/n transferred in step S28 to the interface output section 6 (step S29).

The interface output section 6 receives the resent control parameter data 1/n (step S30), and sets the resent control parameter data 1/n therein (step S31). When the resent control parameter data 1/n is set normally, the interface output section 6 generates a response message including the result that the setting for the resent control parameter data 1/n has been terminated normally, the response message is assigned to the device driver 4B (step S32), and interface output section 6 sends the response message to the device driver 4B (step S33).

After receiving the response message from the interface output section 6 (step S34), the device driver 4B generates a response message including the result that the setting for the control parameter data 1/n has been terminated normally, assigns the response message to the status information generating and sending section 4A (step S35), and sends the response message to the status information generating and sending section 4A (step S36).

When receiving the response message from the device driver 4B (step S37), the status information generating and sending section 4A generates a response message which is assigned to the control information terminal 2 (step S38) including the result that the setting for the control parameter data 1/n has been terminated normally, and sends the response message having a normal termination flag included in the status information signal region to the control information terminal 2 (step S39).

The control information terminal 2 receives the response message sent from the status information generating and sending section 4A (step S40). After receiving the response message having the erected normal setting termination flag for the resent control parameter data 1/n from the status information generating and sending section 4A in step S40, the control information terminal 2 resends a control parameter data 2 of n (hereinafter, referred to as resent control parameter data 2/n) to the status information generating and sending section 4A (step S41). Then, after receiving the resent control parameter data 2/n (step S42), the status information generating and sending section 4A transfers the resent control parameter data 2/n to the device driver 4B (step S43).

The resent control parameter data 2/n transferred in step S43 is processed in the device driver 4B to be able to be set in the interface output section 6, and is set normally in the interface output section 6. After that, the status information generating and sending section 4A receives the response message including the normal termination flag for the resent control parameter data 2/n from the device driver 4B. The status information generating and sending section 4A generates a response message assigned to the control information terminal 2 (step S44), and sends the response message to the control information terminal 2 (step S45).

When the retransmission process for the control parameter data is repeated for the number of the resent control parameter data (step S46), the response messages including normal termination flags corresponding to all the resent control parameter data are sent to the control information terminal 2 (step S47), and the retransmission process for the control parameter data is terminated if the control information terminal 2 receives all of the response messages (step S48).

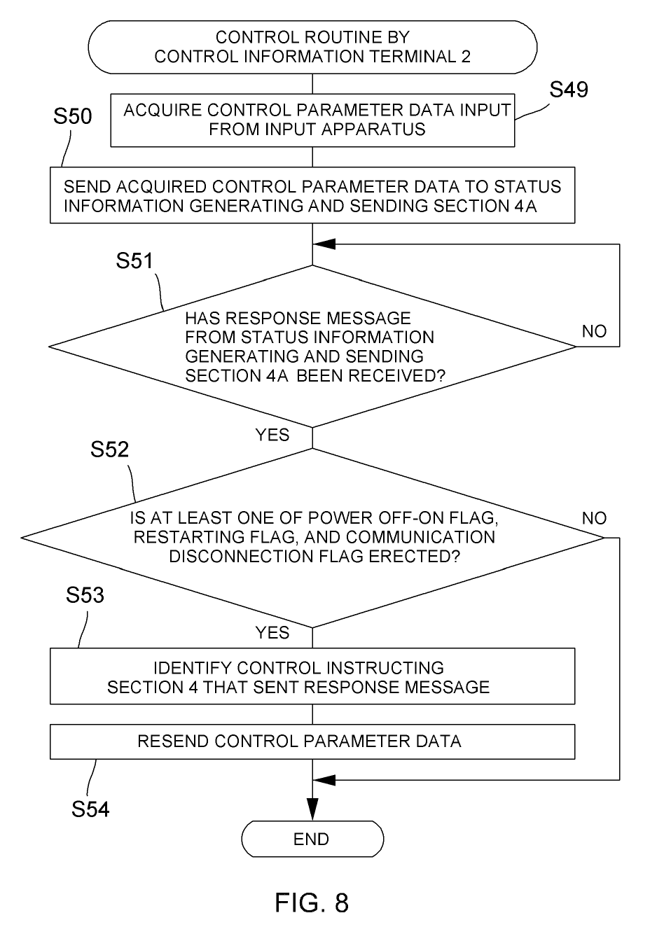

FIG. 8 depicts an exemplary operation of the control information terminal 2 when the control parameter data is resent because the power supply has been turned OFF-ON, has been restarted, and communication disconnection has occurred only in the control instructing section 4.

The control information terminal 2 acquires n pieces of control parameter data (n is an integer number more than or equal to 1) input by the input apparatus (step S49). After that, the control information terminal 2 sends the control parameter data 1/n to the status information generating and sending section 4A (step S50). After sending the control parameter data 1/n to the status information generating and sending section 4A, the control information terminal 2 judges whether or not a response message corresponding to the control parameter data 1/n has been received from the status information generating and sending section 4A (step S51). If the control information terminal 2 has not received the response message, the following process is delayed until the message is received. When receiving the message, the control information terminal 2 refers to a status information signal region within the response message (step S52), identifies the control instructing section 4 that sent the response message using an ID information signal. If at least one of the power supply OFF-ON flag, the restarting flag, or the communication disconnection flag is included (step S53), the control information terminal 2 resends the control parameter data 1/n to the status information generating and sending section 4A in the control instructing section 4 having the identified ID (step S54). When none of the power supply OFF-ON flag, the restarting flag, or the communication disconnection flag is included in the status information signal region within the response message, in other words, when the normal termination flag is included, the control parameter data is not resent.

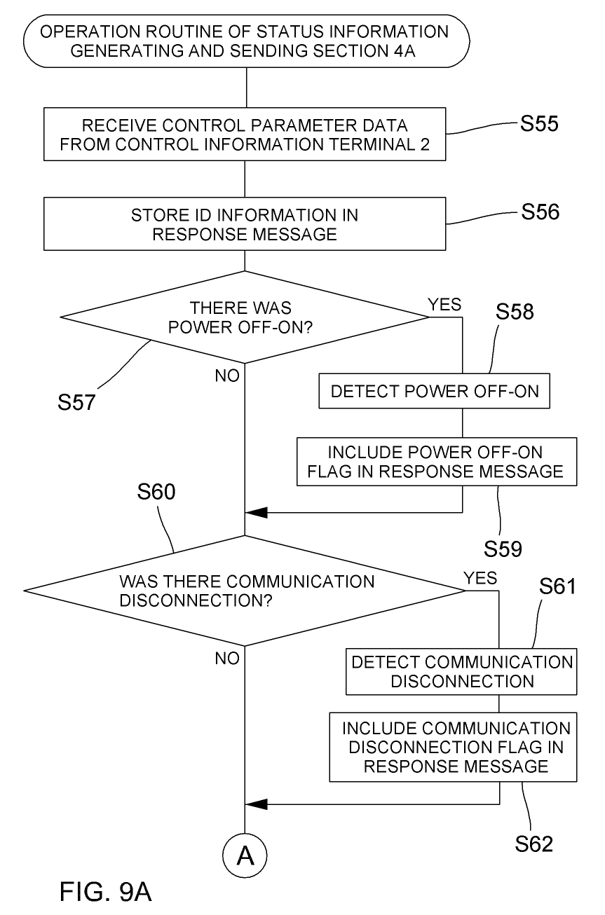

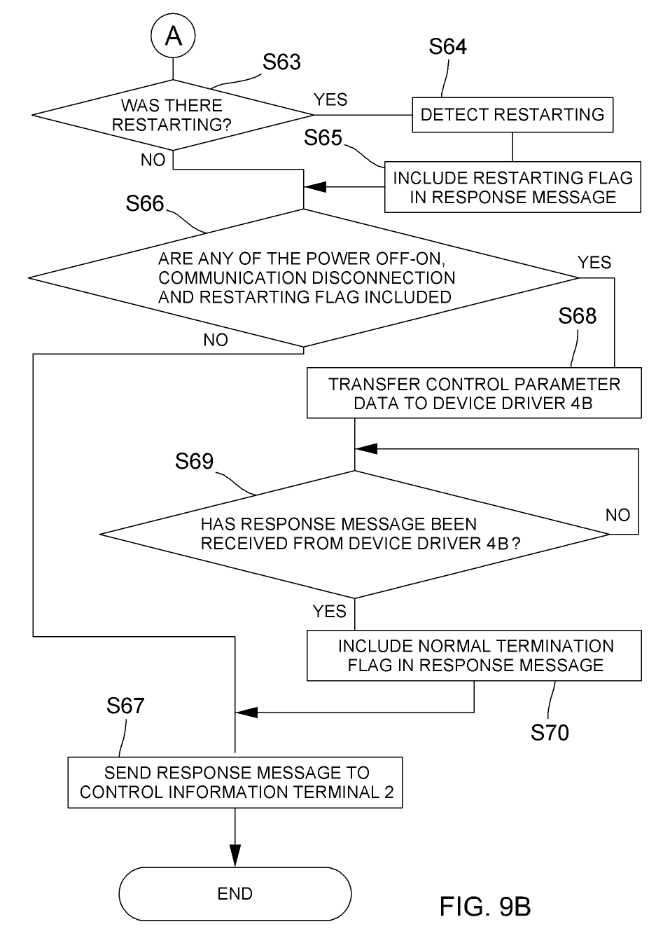

FIG. 9A and FIG. 9B depict an exemplary operation of the status information generating and sending section 4A when the control parameter data is resent because any one of the power supply OFF-ON, the restarting, or communication disconnection has occurred only in the control instructing section 4.

The status information generating and sending section 4A receives a control parameter data from the control information terminal 2 (step S55), and stores an ID information signal for specifying the status information generating and sending section 4A in a response message (step S56).

After that, the status information generating and sending section 4A judges whether the power supply to the control instructing section 4 is turned OFF-ON or not (step S57), detects the power supply OFF-ON if it occurs (step S58), and erects the power supply OFF-ON flag in the status information signal region within the response message (step S59). Next, the status information generating and sending section 4A judges whether the communication between the control information terminal 2 and the control instructing section 4 is disconnected or not (step S60), detects the communication disconnection if the communication is disconnected (step S61), and erects the communication disconnection flag in the status information signal region within the response message (step S62). Then, the status information generating and sending section 4A judges whether the control instructing section 4 is restarted or not (step S63), detects the restarting if the control instructing section 4 is restarted (step S64), and erects the restarting flag in the status information signal region within the response message (step S65).

As described above, after the power supply OFF-ON, the communication disconnection, or the restarting condition are present, the status information generating and sending section 4A determines whether or not any of the respective flags is included (step S66), and, if not, sends the response message to the control information terminal 2 (step S67).

Moreover, the status information generating and sending section 4A transfers the received control parameter data to the device driver 4B when any of the flags is erected as determined in step S66 (step S68). After that, the status information generating and sending section 4A judges whether the status information generating and sending section 4A has received the response message from the device driver 4B or not (step S69). If the response message has not been received, the following process is delayed until receiving the response message. If the response message is received, the status information generating and sending section 4A erects the normal termination flag in the status information signal region within the response message (step S70). Then, the status information generating and sending section 4A generates and sends the response message to the control information terminal 2 (step S67), and terminates the process.

While exemplary embodiments have been set forth above for the purpose of disclosure, modifications of the disclosed embodiments as well as other embodiments thereof may occur to those skilled in the art. Accordingly, it is to be understood that the disclosure is not limited to the above precise embodiments and that changes may be made without departing from the scope. Likewise, it is to be understood that it is not necessary to meet any or all of the stated advantages or objects disclosed herein to fall within the scope of the disclosure, since inherent and/or unforeseen advantages of the may exist even though they may not have been explicitly discussed herein.

What is claimed is:

1. An interface information outputting system comprising:
a control information terminal operative to supply control parameter data via a communication line;
a control instructing section operative to receive the control parameter data via the communication line and to output a control instructing signal on the basis of the received control parameter data; and
an interface output section operative to perform an interface output in accordance with the control instructing signal received from the control instructing section;
wherein the control instructing section includes a status information generating and sending section that is operative to send to the control information terminal via the communication line (a) an ID information signal including information pertaining to an identity of the control instructing section and (b) a status information signal including status information indicating present operational conditions; and
wherein the control information terminal is operative to receive the status information signal via the communication line and to utilize at least a portion of information from the status information signal in control parameter data sent subsequently therefrom.

2. The interface information outputting system according to claim 1,
wherein the status information signal includes a retransmission request for the control parameter data, the retransmission request corresponding to the present operational conditions of the control instructing section; and
wherein the control information terminal is operative to utilize at least a portion of information from the retransmission request in control parameter data sent subsequently therefrom.

3. The interface information outputting system of claim 1, wherein the communication line includes a wired connection.

4. The interface information outputting system of claim 1, wherein the communication line includes a wireless connection.

5. The interface information outputting system of claim 1, wherein the status information signal includes status information indicating at least one abnormal condition.

6. The interface information outputting system of claim 5, wherein the at least one abnormal condition includes at least one of power OFF-ON, communication disconnection, and restarting.

7. The interface information outputting system of claim 1, wherein the status information signal includes status information indicating normal termination.

8. A method of providing a control instructing signal comprising:
supplying a control parameter from a control information terminal via a communication line;
receiving the control parameter by a control instructing section via the communication line;
outputting, by the control instructing section, a control instructing signal based on the received control parameter data;
receiving, by an interface output section, receiving the control instructing signal from the control instructing section; and
performing, by the interface output section, an interface output in accordance with the control instructing signal;
wherein the control instructing section includes a status information generating and sending section that is operative to send to the control information terminal via the communication line (a) an ID information signal including information pertaining to an identity of the control instructing section and (b) a status information signal including status information indicating present operational conditions; and
wherein the control information terminal is operative to receive the status information signal via the communication line and to utilize at least a portion of information from the status information signal in control parameter data sent subsequently therefrom.

9. The method of claim 8,
wherein the status information signal includes a retransmission request for the control parameter data, the retransmission request corresponding to the present operational conditions of the control instructing section; and
wherein the control information terminal is operative to utilize at least a portion of information from the retransmission request in control parameter data sent subsequently therefrom.
